(19) United States
(12) Patent Application Publication
(10) Pub. No.: US 2026/0109614 A1
(43) Pub. Date: Apr. 23, 2026

(54) RECYCLABLE POLYMER TEMPLATE AGENT, HIERARCHICAL GRADIENT PORE BETA ZEOLITE AND PREPARATION METHODS THEREOF

(71) Applicant: MINJIANG UNIVERSITY, Fuzhou (CN)

(72) Inventors: Yuan HU, Fuzhou (CN); Yanhui YANG, Fuzhou (CN)

(73) Assignee: MINJIANG UNIVERSITY, Fuzhou (CN)

(21) Appl. No.: 19/428,326

(22) Filed: Dec. 22, 2025

Related U.S. Application Data
(63) Continuation of application No. PCT/CN2024/097504, filed on Jun. 5, 2024.

(30) Foreign Application Priority Data
Jun. 28, 2023 (CN) 202310775013.5

(51) Int. Cl. C01B 39/04

(52) U.S. Cl. CPC C01B 39/04; C01P 2002/72; C01P 2004/03; C01P 2006/12; C01P 2006/14

(57) ABSTRACT

The present invention relates to the field of zeolite technology, and more particularly to a recyclable polymer template agent, a hierarchical gradient pore Beta zeolite, and a green preparation method thereof. By synthesizing a polymer template agent and utilizing the unique temperature sensitivity conferred by the combination of the hydrophilic quaternary amide group and the hydrophobic isopropyl group in the polyquaternary ammonium salt structure of the recyclable polymer template agent provided by the present invention, the zeolite precursor is locked inside the gel at the zeolite synthesis temperature, directing the formation of the zeolite crystal structure; after crystallization is complete, the reaction temperature is lowered to room temperature, the polymer shell opens, and the locked zeolite crystals inside are released via a diffusion mechanism, followed by centrifugation to separate the polymer from the zeolite for removal.

### CROSS-REFERENCE TO RELATED APPLICATIONS

The application claims priority to Chinese patent application No. 202310775013.5, filed on Jun. 28, 2023, the entire contents of which are incorporated herein by reference.

### TECHNICAL FIELD

The present invention relates to the field of zeolite technology, and more specifically, to a recyclable polymer template agent, a hierarchical gradient pore Beta zeolite, and an environmentally friendly preparation method thereof.

### BACKGROUND

The structure of a Beta zeolite is formed by stacking A-type, B-type, and C-type structures along the a-direction as shown in FIG. 1 to form a stacking fault structure. It forms straight twelve-membered ring channels intersecting perpendicularly in the b and c directions. These channels form an open, three-dimensional intersecting pore system without cage-like confinements with a pore size of about 0.66×0.76 nm. In the a-direction, it forms linear tortuous channels with a pore size of about 0.56×0.65 nm. The cage-free three-dimensional pore system of the Beta zeolite not only facilitates the diffusion of reactants and products but also endows it with stronger catalytic stability and product shape selectivity. Therefore, Beta zeolite has been widely used in fine chemical synthesis and the petrochemical industry. However, the presence of small micropores strongly affects the mass transfer of substances with sizes close to or larger than their micropore diameter, hindering their large-scale industrial application. Hierarchical pore Beta zeolite, possessing combinations of micro/mesopores, micro/macropores, or micro/meso/macropores, exhibit superior performance compared to microporous Beta zeolite in catalytic reactions and adsorption, effectively overcoming the limitations of traditional Beta zeolite having only micropores.

Chinese patent document (CN112591765A) uses a neutral polymer to greenly prepare a hierarchical pore Beta zeolite, and subjects the prepared zeolite to acid treatment to remove the template agent, obtaining a hierarchical pore Beta zeolite. Chinese patent document (CN112939018A) uses non-toxic, inexpensive, recyclable 2-pyrrolidone, N-methyl-2-pyrrolidone, N-ethyl-2-pyrrolidone, N-isopropyl-2-pyrrolidone, or mixtures thereof as organic mineralizers, replacing highly toxic and corrosive hydrofluoric acid or fluorine-containing salts and other inorganic mineralizers, to prepare high-silica Beta zeolite, but the preparation process requires the use of microporous template agents such as tetraethylammonium hydroxide, tetraethylammonium bromide, or tetraethylammonium chloride. Chinese patent document (CN111017954A) uses tetraethylammonium hydroxide or tetraethylammonium bromide as a microporous template agent and alcohols, organic amines, or carbonates as fillers to prepare Beta zeolite with open macropores. Published patent (CN111333082A) uses tetraethylammonium hydroxide, tetraethylammonium bromide, tetraethylammonium chloride, or tetraethylammonium fluoride as template agents, adds seeds and an appropriate amount of hydrofluoric acid to prepare all-silica H-Beta zeolite. Published patent (CN112607747B) discloses a green and efficient synthesis method for high-silica Beta zeolite, using an aluminum source, inorganic base, tetraethylammonium hydroxide, and a fluorine-free mineralizer, and preparing mesoporous high-silica Beta zeolite via steam-assisted crystallization.

The aforementioned technical solutions for achieving hierarchical pore Beta zeolite involve expensive template agent synthesis costs, irreversible destruction of the template agent structure making it non-recyclable, and mostly require high-temperature calcination to remove the template agent, which readily causes environmental pollution and potential damage to the zeolite structure.

### SUMMARY

To address this, there is a need to provide an environmentally friendly template agent, a hierarchical pore Beta zeolite, and preparation methods thereof, to solve the problems in the prior art where mesoporous or macroporous template agents require high-temperature calcination for removal, leading to structural damage and inability to be reused and recycled, while also addressing the issues of high production costs and environmental pollution in the production of hierarchical pore Beta zeolite.

To achieve the above object, in a first aspect, the present invention provides a recyclable polymer template agent having a number average molecular weight of 28,000 to 35,000 g/mol and having the following chemical structural formula:

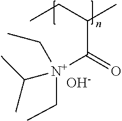

wherein n is an integer greater than 1.

In a second aspect, the present invention provides a method for preparing the recyclable polymer template agent according to the first aspect of the present invention, comprising the following steps:
adding isopropylacrylamide and azobisisobutyronitrile to a polymerization tube containing anhydrous tetrahydrofuran, performing an oil bath reaction under a nitrogen protection environment, cooling, evaporating the solvent, dissolving in acetone, then dropwise adding into n-hexane, performing suction filtration, and vacuum drying to obtain poly(N-isopropylacrylamide);
dissolving said poly(N-isopropylacrylamide) in diethyl ether, adding bromoethane, and reacting to obtain a polyquaternary ammonium hydrohalide salt solution;
treating said polyquaternary ammonium hydrohalide salt solution with a strongly basic anion exchange resin, and filtering to obtain a polyquaternary ammonium hydroxide solution;
water-bath cooling the polyquaternary ammonium hydroxide solution, adding an acid for neutralization, performing reduced-pressure distillation, cooling again, performing extraction, separating layers, and vacuum removing volatile components to obtain said recyclable polymer template agent.

As a preferred embodiment of the present invention, the molar usage amounts of said isopropylacrylamide, azobisisobutyronitrile, and anhydrous tetrahydrofuran are respectively: (8-12):(0.03-0.09):(90-210).

As a preferred embodiment of the present invention, the temperature of said oil bath reaction is 55-65° C., the oil bath reaction time is 18-36 h, the temperature of said vacuum drying is 25-30° C., and the vacuum drying time is 40-48 h.

As a preferred embodiment of the present invention, the amount of said bromoethane used is 180-420 mmol, the reaction temperature is 40-45° C., and the reaction time is 20-30 h.

In a third aspect, the present invention provides a method for preparing a hierarchical pore Beta zeolite, comprising the following steps:
mixing water, an aluminum source, an alkali source, and the recyclable polymer template agent according to the first aspect of the present invention uniformly, and adding a silicon source in batches to obtain a gel, wherein, based on molar parts, said gel comprises 1,500-6,000 parts H₂O, 100-300 parts SiO₂, 1 part Al₂O₃, 2.0-2.6 parts Na₂O and 0.012-0.026 parts of said recyclable polymer template agent;
aging said gel, then placing it in a reaction kettle for crystallization to obtain a sample A;
centrifuging said sample A to remove said recyclable polymer template agent, and drying to obtain said hierarchical pore Beta zeolite.

In the preparation of the hierarchical pore Beta zeolite, the amount of the recyclable polymer template agent used is critical; an optimal range exists for effective pore structure direction. Through extensive experimental exploration, it was found that when its amount, relative to the molar parts of SiO₂, Na₂O, Al₂O₃, and H₂O, is within the above range, the special groups in the structure of the recyclable polymer template agent can effectively function at the zeolite synthesis temperature, directing the formation of the zeolite crystal structure, and releasing the zeolite crystals after cooling upon completion of crystallization. If the amount is too small, the formed mesopore size is too small, making it difficult to form hierarchical pores with small micropores; if the amount is too large, the formed mesopore size approaches macropores, which is also not conducive to forming hierarchical pores.

As a preferred embodiment of the present invention, the aging temperature of said gel is 23-25° C., the aging time is 2-4 h, the crystallization temperature is 140-180° C., and the crystallization time is 24-72 h.

As a preferred embodiment of the present invention, said aluminum source comprises sodium aluminate and/or aluminum sulfate, said silicon source comprises one or a combination of two or more selected from silica sol, industrial silica gel, and fumed silica, and said alkali source is sodium hydroxide.

As a preferred embodiment of the present invention, the centrifugation speed is 5,000-8,000 rpm, the centrifugation temperature is 20-35° C., and the centrifugation time is 10-30 min.

In a fourth aspect, the present invention provides a hierarchical pore Beta zeolite prepared by the preparation method according to the third aspect of the present invention, wherein the mesopore pore size of said hierarchical pore Beta zeolite is concentrated in the range of 5-50 nm, the specific surface area is 500-600 m²/g, and the pore volume is 0.36-0.72 cm³/g.

Different from the prior art, the above technical solution synthesizes a recyclable polymer template agent. Utilizing the unique temperature sensitivity conferred by the combination of the hydrophilic quaternary amide group and the hydrophobic isopropyl group in the polyquaternary ammonium salt structure of the recyclable polymer template agent provided by the present invention, the zeolite precursor is locked inside the gel at the zeolite synthesis temperature, directing the formation of the zeolite crystal structure; after crystallization is complete, the reaction temperature is lowered to room temperature, the polymer shell opens, and the locked zeolite crystals inside are released via a diffusion mechanism, followed by centrifugation to separate the polymer from the zeolite for removal. In the process of applying the recyclable polymer template agent of the present invention to prepare the hierarchical pore Beta zeolite, high-temperature calcination for its removal is not required, greatly reducing energy consumption. The removed recyclable polymer template agent can be repeatedly recycled and reused in the zeolite production process, saving the application cost of the template agent, and achieving calcination-free pollutant discharge, making it environmentally friendly.

### BRIEF DESCRIPTION OF DRAWINGS

FIG. 1 is a schematic diagram of the stacking fault structure of a Beta zeolite;

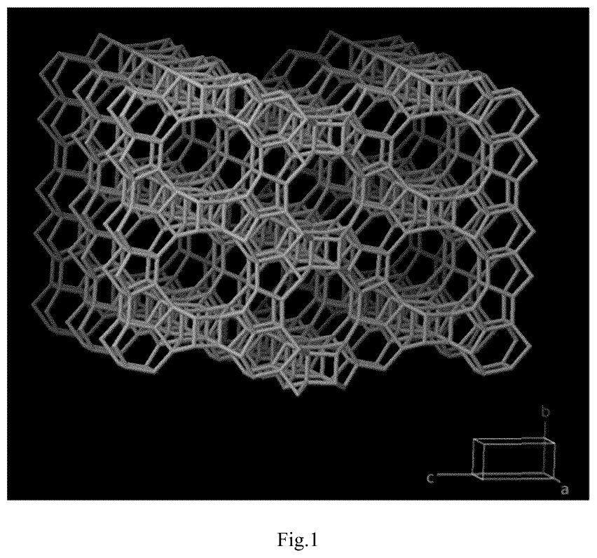

FIG. 2 is an XRD diffraction pattern of the hierarchical pore Beta zeolite prepared in Example 1 of the present invention;

FIG. 3 is an SEM photograph of the hierarchical pore Beta zeolite prepared in Example 1 of the present invention;

FIG. 4 is an XRD diffraction pattern of the sample prepared in Comparative Example 1 of the present invention;

FIG. 5 is an XRD diffraction pattern of the sample prepared in Comparative Example 2 of the present invention;

FIG. 6 is an XRD diffraction pattern of the sample prepared in Comparative Example 3 of the present invention.

### DETAILED DESCRIPTION OF THE EMBODIMENTS

The technical content, structural features, achieved objectives, and effects of the technical solution are described in detail below with reference to specific embodiments and accompanying drawings.

Reference to “an embodiment” herein means that a particular feature, structure, or characteristic described in connection with the embodiment may be included in at least one embodiment of the present application. The appearance of the term “embodiment” in various places in the specification does not necessarily refer to the same embodiment, nor is it specifically limited to being independent of or associated with other embodiments. In principle, in this application, as long as there is no technical contradiction or conflict, the various technical features mentioned in the embodiments can be combined in any manner to form corresponding implementable technical solutions.

Unless otherwise defined, the meanings of the technical terms used herein are the same as those usually understood by those skilled in the technical field to which this application belongs; the use of related terms herein is only for describing specific embodiments and is not intended to limit the application.

In the description of this application, the term “and/or” is an expression describing the logical relationship between objects, indicating that three relationships can exist, for example, A and/or B, indicating: the existence of A, the existence of B, and the simultaneous existence of A and B. In addition, the character “/” in this text generally indicates that the associated objects before and after are in an “or” logical relationship.

In this application, terms such as “first” and “second” are used only to distinguish one entity or operation from another entity or operation, and do not necessarily require or imply any actual quantitative, primary/secondary, or sequential relationship between these entities or operations.

Without more limitations, in this application, the terms “comprising,” “including,” “having,” or other similar expressions used in the text are intended to cover non-exclusive inclusion. These expressions do not exclude the possibility that in the process, method, or product including the stated elements, there may also be other elements, so that a process, method, or product including a series of elements may not only include those explicitly listed elements, but also include other elements not explicitly listed, or inherent elements of such process, method, or product.

Consistent with the understanding in the “Guidelines for Examination,” in this application, expressions such as “greater than,” “less than,” “exceeding,” etc., are understood to exclude the base number; expressions such as “above,” “below,” “within,” etc., are understood to include the base number. Furthermore, in the description of the embodiments of this application, the meaning of “a plurality” is two or more (including two), and similar expressions related to “multiple” are understood similarly, such as “multiple groups,” “multiple times,” etc., unless otherwise explicitly specified.

In the description of the embodiments of this application, the spatially related expressions used, such as “center,” “longitudinal,” “transverse,” “length,” “width,” “thickness,” “upper,” “lower,” “front,” “rear,” “left,” “right,” “vertical,” “horizontal,” “vertical,” “top,” “bottom,” “inner,” “outer,” “clockwise,” “counterclockwise,” “axial,” “radial,” “circumferential,” etc., indicate the orientation or positional relationship based on the orientation or positional relationship shown in the specific embodiments or drawings, and are only for the convenience of describing the specific embodiments of this application or for the reader's understanding, rather than indicating or implying that the indicated device or component must have a specific orientation, be constructed or operated in a specific orientation, and therefore cannot be understood as a limitation of the embodiments of this application.

Unless otherwise explicitly specified or defined, in the description of the embodiments of this application, the terms “installed,” “connected,” “linked,” “fixed,” “set,” etc., should be understood broadly. For example, “connected” can be a fixed connection, a detachable connection, or an integrated connection; it can be a mechanical connection, an electrical connection, or a communication connection; it can be a direct connection, or an indirect connection through an intermediary; it can be the internal communication between two components or the interaction relationship between two components. Those skilled in the art of this application can understand the specific meanings of the above terms in the embodiments of this application according to the specific situation.

To overcome the limitation caused by the small micropores of Beta zeolite hindering mass transfer and to expand the industrial application scope and fields of Beta zeolite, as listed in the background art, research on nanoscale hierarchical pore Beta zeolite is increasing. The use of polyquaternary ammonium salts (such as Polyquaternium-6, Polyquaternium-11, or Polyquaternium-32) as template agents for synthesizing zeolite has also been applied in the synthesis of nano-EMT zeolite, large-pore EMM-23 zeolite zeolite, and Beta-FER intergrowth zeolite. However, if Polyquaternium-6, Polyquaternium-11, Polyquaternium-32, or other such polyquaternary ammonium salts are directly used as template agents to solve the technical problem of the present invention, the inventors found that they cannot be removed by centrifugation and still require the traditional high-temperature calcination removal method. The high-temperature calcination removal method not only emits undesirable environmental pollutants but also causes severe dealumination of the Beta zeolite framework and partial framework collapse, leading to a significant decrease in crystallinity, affecting the practical industrial application of Beta zeolite. Therefore, the applicant took a different approach and, through continuous experimental adjustment and theoretical analysis, prepared a polyquaternary ammonium salt polymer template agent whose structure combines both a hydrophilic quaternary amide group and hydrophobic isopropyl groups. Utilizing the temperature sensitivity brought about by its special structure, it can lock the zeolite precursor inside the gel at the zeolite synthesis temperature, directing the formation of the zeolite crystal structure. After crystallization is complete, the reaction temperature is lowered to room temperature, the polymer shell opens, and the locked zeolite crystals inside are released through a diffusion mechanism, and the recyclable polymer template agent can be separated from the zeolite and removed solely by centrifugation.

In the present invention, unless otherwise specified, the reagents and raw materials used are commercially available.

In the present invention, unless otherwise specified, the number average molecular weight of the recyclable polymer template agent is measured using a gel permeation chromatograph, with specific test conditions and methods as follows:

A liquid chromatograph (Shimadzu, Japan) model LC-10AD/SPD-10A equipped with a gel chromatography column model Shodex KF-803 is used for testing. Before testing, 4 mg of the recyclable polymer template agent is dissolved in 2 mL of tetrahydrofuran solution, filtered through a 2 μm filter membrane, and then 20 L of the above sample is taken for testing the molecular weight distribution of the recyclable polymer template agent in the liquid chromatograph. The test temperature is 30° C., using chromatographically pure TCM as the solvent, with a solvent flow rate of 1 mL/min, and polystyrene as the standard sample.

In the present invention, unless otherwise specified, the mesopore size of the hierarchical pore Beta zeolite is measured by physical adsorption, with specific test conditions and methods as follows:

A physical adsorption instrument (Micromeritics, USA) model Micromeritics 2020 is used for testing. Before testing, the sample is pretreated under vacuum at 150° C. for 12 h, then static adsorption is performed using Ar as the adsorbate at −196° C. to determine the adsorption-desorption curve of the sample. The Barrett-Joyner-Halenda (BJH) model is used to obtain the mesopore size distribution of the sample.

In the present invention, unless otherwise specified, the specific surface area of the hierarchical pore Beta zeolite is measured by physical adsorption, with specific test conditions and methods as follows:

A physical adsorption instrument (Micromeritics, USA) model Micromeritics 2020 is used for testing. Before testing, the sample is pretreated under vacuum at 150° C. for 12 h, then static adsorption is performed using Ar as the adsorbate at −196° C. to determine the adsorption-desorption curve of the sample. Based on the Brunauer-Emmet-Teller (BET) equation, the adsorption-desorption isotherm is plotted, and the linear part (0.05<P/P₀<0.30) of the adsorption isotherm is used with the BET equation to calculate the total specific surface area.

In the present invention, unless otherwise specified, the pore volume of the hierarchical pore Beta zeolite is measured by physical adsorption, with specific test conditions and methods as follows:

A physical adsorption instrument (Micromeritics, USA) model Micromeritics 2020 is used for testing. Before testing, the sample is pretreated under vacuum at 150° C. for 12 h, then static adsorption is performed using Ar as the adsorbate at −196° C. to determine the adsorption-desorption curve of the sample. The micropore and mesopore volumes are calculated using the t-plot method.

In the present invention, unless otherwise specified, the crystallinity is measured by X-ray diffraction (XRD) method, with specific test conditions as follows:

A Rigaku D-Max 2550 X-ray diffractometer (Rigaku, Japan) is used for phase structure analysis of the synthesized zeolite samples. Test conditions are: Cu target, Kα radiation (λ=1.5418 Å), tube voltage 40 kV, tube current 40 mA. Wide-angle scanning range 2θ=5-40°, scanning rate 7°/min. The relative crystallinity mentioned in the embodiments of this application is based on the ASTM D3906-03 (2013) standard, using the ratio of the integral area at 22.4°±0.2° 2θ in the XRD pattern of the obtained product to that of a Beta zeolite standard sample. The standard sample is a Beta zeolite with a SiO₂/Al₂O₃ molar ratio of 25 produced by Nankai University Catalyst Factory, and its crystallinity is defined as 100%.

In the present invention, unless otherwise specified, the SiO₂/Al₂O₃ ratio is measured by ICP method, with specific test conditions as follows:

An OPTIMA 8000 inductively coupled plasma optical emission spectrometer from Perkin-Elmer, USA, is used. First, 10 mg of the sample is dissolved in aqua regia, transferred to a microwave digester, heated to 200° C. and held for 2 h for complete dissolution; then cooled to room temperature and made up to volume with a volumetric flask for later use; then standard solutions of the metal elements to be measured are prepared as reference standards to draw a standard curve; then the sample to be tested is introduced using argon as the carrier gas; finally, the concentration of the metal elements to be measured is obtained and recorded.

In the present invention, unless otherwise specified, the morphology of the zeolite is characterized by SEM, with specific test conditions as follows:

SEM is performed using a Helios G4 CX focused ion beam (FIB) dual-beam field emission electron microscope (Thermo Scientific, USA). A small amount of the dried sample is dispersed in an ethanol solution, ultrasonicated for 10 min for uniform dispersion, then one drop of the supernatant is dropped onto a clean silicon wafer, placed in an oven at 60° C. for 10 min, then sputter-coated with gold, and morphology characterization is performed to obtain electron micrographs for analysis.

### Example 1 Recyclable Polymer Template Agent and Its Preparation Method

12 mmol of isopropylacrylamide and 0.09 mmol of azobisisobutyronitrile were added to a polymerization tube containing 210 mmol of anhydrous tetrahydrofuran. The reaction was carried out under nitrogen protection in an oil bath at 65° C. for 36 h, cooled to room temperature, the solvent was evaporated, dissolved in a small amount of acetone, then dropwise added into n-hexane, suction filtered, and vacuum dried at 30° C. for 48 h to obtain a white solid of poly(N-isopropylacrylamide). The above solid was dissolved in the organic solvent diethyl ether, 420 mmol of bromoethane was added, and the reaction was carried out at 45° C. for 30 h to obtain a solution of polyquaternary ammonium hydrohalide salt; the above solution was treated with a strongly basic anion exchange resin (Type I, OH⁻ form) until no halide ions were detected in the liquid phase, then filtered to obtain a solution of polyquaternary ammonium hydroxide; under room temperature water-bath cooling, the polyquaternary ammonium hydroxide solution was neutralized with an acid, then subjected to reduced-pressure distillation to remove the organic solvent, the above liquid was cooled, extracted with diethyl ether, the ether phase was separated and removed, and volatile components were removed under vacuum to obtain the polyquaternary ammonium salt PENOH having the following chemical structure I. Gel permeation chromatography measured the number average molecular weight of polyquaternary ammonium salt PENOH as 35,000 g/mol, which is the recyclable polymer template agent provided by the present invention.

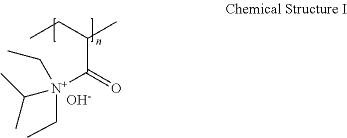

### Example 2 Recyclable Polymer Template Agent and Its Preparation Method

11 mmol of isopropylacrylamide and 0.08 mmol of azobisisobutyronitrile were added to a polymerization tube containing 180 mmol of anhydrous tetrahydrofuran. The reaction was carried out under nitrogen protection in an oil bath at 60° C. for 32 h, cooled to room temperature, the solvent was evaporated, dissolved in a small amount of acetone, then dropwise added into n-hexane, suction filtered, and vacuum dried at 30° C. for 48 h to obtain a white solid of poly(N-isopropylacrylamide). The above solid was dissolved in the organic solvent diethyl ether, 360 mmol of bromoethane was added, and the reaction was carried out at 45° C. for 28 h to obtain a solution of polyquaternary ammonium hydrohalide salt; the above solution was treated with a strongly basic anion exchange resin (Type I, OH form) until no halide ions were detected in the liquid phase, then filtered to obtain a solution of polyquaternary ammonium hydroxide; under room temperature water-bath cooling, the polyquaternary ammonium hydroxide solution was neutralized with an acid, then subjected to reduced-pressure distillation to remove the organic solvent, the above liquid was cooled, extracted with diethyl ether, the ether phase was separated and removed, and volatile components were removed under vacuum to obtain the polyquaternary ammonium salt PENOH having chemical structure I. Gel permeation chromatography measured the number average molecular weight of polyquaternary ammonium salt PENOH as 33,000 g/mol, which is the recyclable polymer template agent provided by the present invention.

### Example 3 Recyclable Polymer Template Agent and Its Preparation Method

10 mmol of isopropylacrylamide and 0.07 mmol of azobisisobutyronitrile were added to a polymerization tube containing 150 mmol of anhydrous tetrahydrofuran. The reaction was carried out under nitrogen protection in an oil bath at 60° C. for 30 h, cooled to room temperature, the solvent was evaporated, dissolved in a small amount of acetone, then dropwise added into n-hexane, suction filtered, and vacuum dried at 30° C. for 48 h to obtain a white solid of poly(N-isopropylacrylamide). The above solid was dissolved in the organic solvent diethyl ether, 300 mmol of bromoethane was added, and the reaction was carried out at 43° C. for 30 h to obtain a solution of polyquaternary ammonium hydrohalide salt; the above solution was treated with a strongly basic anion exchange resin (Type I, OH⁻ form) until no halide ions were detected in the liquid phase, then filtered to obtain a solution of polyquaternary ammonium hydroxide; under room temperature water-bath cooling, the polyquaternary ammonium hydroxide solution was neutralized with an acid, then subjected to reduced-pressure distillation to remove the organic solvent, the above liquid was cooled, extracted with diethyl ether, the ether phase was separated and removed, and volatile components were removed under vacuum to obtain the polyquaternary ammonium salt PENOH having chemical structure I. Gel permeation chromatography measured the number average molecular weight of polyquaternary ammonium salt PENOH as 31,000 g/mol, which is the recyclable polymer template agent provided by the present invention.

### Example 4 Recyclable Polymer Template Agent and Its Preparation Method

9 mmol of isopropylacrylamide and 0.05 mmol of azobisisobutyronitrile were added to a polymerization tube containing 120 mmol of anhydrous tetrahydrofuran. The reaction was carried out under nitrogen protection in an oil bath at 58° C. for 36 h, cooled to room temperature, the solvent was evaporated, dissolved in a small amount of acetone, then dropwise added into n-hexane, suction filtered, and vacuum dried at 30° C. for 48 h to obtain a white solid of poly(N-isopropylacrylamide). The above solid was dissolved in the organic solvent diethyl ether, 240 mmol of bromoethane was added, and the reaction was carried out at 40° C. for 28 h to obtain a solution of polyquaternary ammonium hydrohalide salt; the above solution was treated with a strongly basic anion exchange resin (Type I, OH⁻ form) until no halide ions were detected in the liquid phase, then filtered to obtain a solution of polyquaternary ammonium hydroxide; under room temperature water-bath cooling, the polyquaternary ammonium hydroxide solution was neutralized with an acid, then subjected to reduced-pressure distillation to remove the organic solvent, the above liquid was cooled, extracted with diethyl ether, the ether phase was separated and removed, and volatile components were removed under vacuum to obtain the polyquaternary ammonium salt PENOH having chemical structure I. Gel permeation chromatography measured the number average molecular weight of polyquaternary ammonium salt PENOH as 29,000 g/mol, which is the recyclable polymer template agent provided by the present invention.

### Example 5 Recyclable Polymer Template Agent and Its Preparation Method

8 mmol of isopropylacrylamide and 0.03 mmol of azobisisobutyronitrile were added to a polymerization tube containing 90 mmol of anhydrous tetrahydrofuran. The reaction was carried out under nitrogen protection in an oil bath at 55° C. for 18 h, cooled to room temperature, the solvent was evaporated, dissolved in a small amount of acetone, then dropwise added into n-hexane, suction filtered, and vacuum dried at 25° C. for 48 h to obtain a white solid of poly(N-isopropylacrylamide). The above solid was dissolved in the organic solvent diethyl ether, 180 mmol of bromoethane was added, and the reaction was carried out at 40° C. for 20 h to obtain a solution of polyquaternary ammonium hydrohalide salt; the above solution was treated with a strongly basic anion exchange resin (Type I, OH⁻ form) until no halide ions were detected in the liquid phase, then filtered to obtain a solution of polyquaternary ammonium hydroxide; under room temperature water-bath cooling, the polyquaternary ammonium hydroxide solution was neutralized with an acid, then subjected to reduced-pressure distillation to remove the organic solvent, the above liquid was cooled, extracted with diethyl ether, the ether phase was separated and removed, and volatile components were removed under vacuum to obtain the polyquaternary ammonium salt PENOH having chemical structure I. Gel permeation chromatography measured the number average molecular weight of polyquaternary ammonium salt PENOH as 28,000 g/mol, which is the recyclable polymer template agent provided by the present invention.

### Example 6

A Hierarchical Pore Beta zeolite and Its Preparation Method, using the recyclable polymer template agent PENOH provided in Example 1, prepared by hydrothermal method, with specific operating steps as follows:

Hydrothermal preparation of zeolite: First, 0.02 g of NaAlO₂ and 0.010 g of NaOH were added to 13 mL of deionized water, stirred until the solution was clear, then 0.12 g of the recyclable polymer template agent PENOH provided in Example 1 was added and stirred for 0.5 h; then 2.17 g of fumed silica was slowly added to obtain a synthesis gel with a molar composition of 300 SiO₂/1 Al₂O₃/2 Na₂O/6000 H₂O/0.026 Polymer; after stirring at room temperature (25° C.) for 3 h, the obtained gel was transferred to a stainless steel autoclave (50 mL) with a polytetrafluoroethylene liner, placed in a homogeneous reactor with a rotation speed of 100 rpm, and crystallized at 140° C. for 72 h; after crystallization was complete, sample A containing the recyclable polymer template agent PENOH was obtained.

The above sample A was subjected to centrifugation to remove the template agent, simultaneously obtaining the hierarchical pore Beta zeolite. The specific operation was as follows:

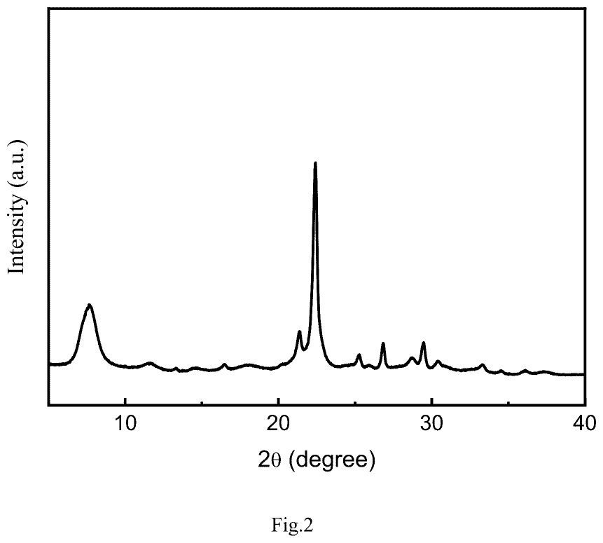

The obtained sample A was placed in a centrifuge tube, set at a centrifugation speed of 6500 rpm, processing temperature of 25° C., centrifuged for 15 min, obtaining the upper layer as the recyclable polymer template agent PENOH and the lower layer as the Beta zeolite; the above Beta zeolite was washed with deionized water to pH≈7, then dried at 105° C. for 12 h to obtain the hierarchical pore Beta zeolite product in powder form. The XRD diffraction pattern of the solid powder shown in FIG. 2 shows that the phase of the obtained product belongs to the Beta zeolite, and ICP measured the SiO₂/Al₂O₃ ratio as 300.

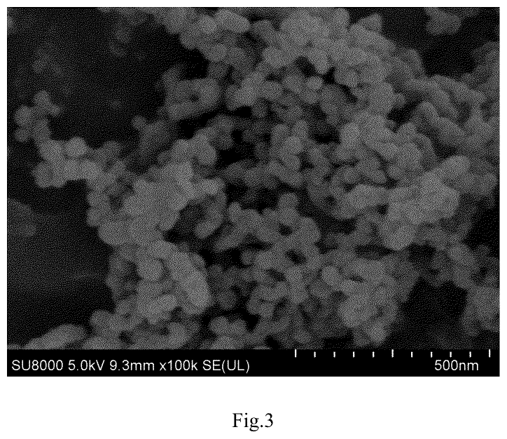

Please refer to FIG. 3. From the SEM morphology characterization diagram of this product, it can be seen that the hierarchical pore Beta zeolite provided in this example is composed of nanocrystals with a particle size of about 30 nm aggregated together.

The hierarchical pore Beta zeolite provided in this example was subjected to Ar adsorption-desorption testing, and the results are shown in Table 1. The Ar adsorption-desorption results indicate that the mesopore size of the hierarchical pore Beta zeolite provided in this example is concentrated at 30 nm, the specific surface area is 596 m²/g, and the pore volume is 0.72 cm³/g.

TABLE 1
Textural Parameters of the Hierarchical Pore Beta zeolite Prepared in Example 6

| Sample | Specific Surface Area (m²/g) | Pore Volume (cm³/g) | Pore Size Distribution (nm) |
|---|---|---|---|
| Beta zeolite | 596 | 0.72 | 30 |

### Example 7 a Hierarchical Pore Beta Zeolite and its Preparation Method (Using the Centrifugally Recovered Polymer Template Agent as the Template Agent)

According to the method of Example 6, the difference is that the PENOH obtained by centrifugation in Example 6 was used as the template agent. XRD determination confirmed that the product obtained in this example belongs to the Beta zeolite phase, and ICP measured the SiO₂/Al₂O₃ ratio as 300.

The XRD diffraction pattern of the hierarchical pore Beta zeolite in this example is similar to FIG. 2, and the SEM characterization image of the hierarchical pore Beta zeolite is similar to FIG. 3.

The hierarchical pore Beta zeolite provided in this example was subjected to Ar adsorption-desorption testing, and the results are shown in Table 2. The Ar adsorption-desorption results indicate that the mesopore size of the hierarchical pore Beta zeolite provided in this example is concentrated at 30 nm, the specific surface area is 594 m²/g, and the pore volume is 0.70 cm³/g.

TABLE 2
Textural Parameters of the Hierarchical Pore Beta zeolite Prepared in Example 7

| Sample | Specific Surface Area (m²/g) | Pore Volume (cm³/g) | Pore Size Distribution (nm) |
|---|---|---|---|
| Beta zeolite | 594 | 0.70 | 30 |

From the comparison of results in Table 1 and Table 2, for Example 6 using the newly prepared recyclable polymer template agent PENOH to prepare the hierarchical pore Beta zeolite and Example 7 using the recovered polymer template agent PENOH to prepare the hierarchical pore Beta zeolite, the specific surface area and pore volume of the zeolite decreased slightly, by 0.34% and 2.78% respectively. This shows that the recyclable polymer template agent PENOH provided by the present invention, after being removed by centrifugation and recovered for use as a template agent in the next batch of hierarchical pore Beta zeolite preparation, is still very effective, while significantly reducing the cost of the template agent raw material.

### Example 8 a Hierarchical Pore Beta Zeolite and its Preparation Method, Prepared Through the Following Steps

Hydrothermal preparation of zeolite: Using the template agent prepared in Example 4, using aluminum sulfate as the aluminum source and silica sol as the silicon source, the order of adding raw materials was the same as in Example 1, adjusting the addition amounts so that the feed molar ratio satisfied: the synthesis gel composition was 200 SiO₂/1 Al₂O₃/2.4 Na₂O/2800 H₂O/0.022 recyclable polymer template agent PENOH, aged at 25° C. for 4 h, the resulting gel was transferred to a 50 mL stainless steel autoclave with a polytetrafluoroethylene liner, and crystallized at 160° C. for 48 h to obtain sample A.

The above sample A was subjected to centrifugation to remove the template agent, simultaneously obtaining the hierarchical pore Beta zeolite. The specific operation was as follows:

The above sample A was placed in a centrifuge tube, set at a centrifugation speed of 5000 rpm, processing temperature of 25° C., centrifuged for 25 min, obtaining the upper layer as the recyclable polymer template agent PENOH and the lower layer as the hierarchical pore Beta zeolite. The hierarchical pore Beta zeolite obtained by centrifugation was washed with deionized water to pH≈7, then dried at 105° C. for 12 h. XRD determination confirmed that the phase of the obtained product belongs to the Beta zeolite, and ICP measured the SiO₂/Al₂O₃ ratio as 200.

The hierarchical pore Beta zeolite provided in this example was subjected to Ar adsorption-desorption testing. The Ar adsorption-desorption results indicate that the mesopore size is concentrated at 20 nm, the specific surface area is 600 m²/g, and the pore volume is 0.42 cm³/g.

### Example 9 a Hierarchical Pore Beta Zeolite and its Preparation Method, Prepared Through the Following Steps

Hydrothermal preparation of zeolite: Using the recyclable polymer template agent prepared in Example 5, using sodium aluminate as the aluminum source and industrial silica gel as the silicon source, the order of adding raw materials was the same as in Example 1, adjusting the addition amounts so that the feed molar ratio satisfied: the synthesis gel composition was 100 SiO₂/1 Al₂O₃/2.6 Na₂O/1500 H₂O/0.012 Polymer, aged at 25° C. for 4 h, the resulting gel was transferred to a 50 mL stainless steel autoclave with a polytetrafluoroethylene liner, and crystallized at 180° C. for 48 h to obtain sample A.

The above sample A was subjected to centrifugation to remove the template agent, simultaneously obtaining the hierarchical pore Beta zeolite. The specific operation was as follows:

The above sample A was placed in a centrifuge tube, set at a centrifugation speed of 5000 rpm, processing temperature of 25° C., centrifuged for 30 min, obtaining the upper layer as the recyclable polymer template agent PENOH and the lower layer as the hierarchical pore Beta zeolite. The hierarchical pore Beta zeolite obtained by centrifugation was washed with deionized water to pH≈7, then dried at 105° C. for 12 h. XRD determination confirmed that the phase of the obtained product belongs to the Beta zeolite, and ICP measured the SiO₂/Al₂O₃ ratio as 100.

The hierarchical pore Beta zeolite provided in this example was subjected to Ar adsorption-desorption testing. The Ar adsorption-desorption results indicate that the mesopore size is concentrated at 8 nm, the specific surface area is 500 m²/g, and the pore volume is 0.36 cm³/g.

### Comparative Example 1

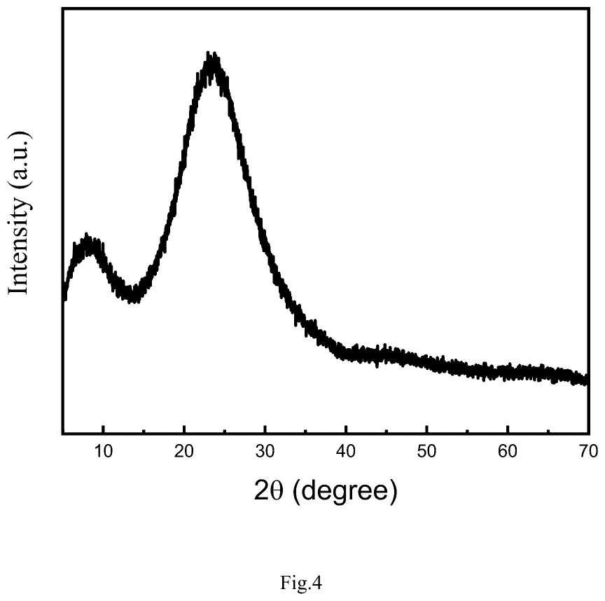

The recyclable polymer template agent PENOH was not added, other operations were the same as in Example 6. XRD determination showed that the obtained product was amorphous silica. The detailed XRD determination results for the product of Comparative Example 1 are shown in FIG. 4.

### Comparative Example 2

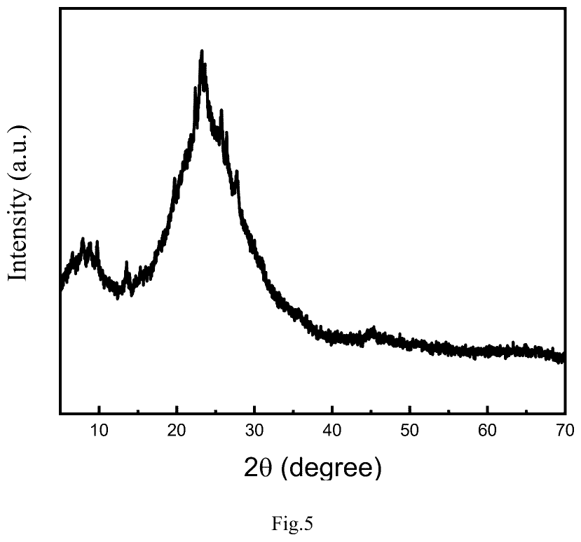

The recyclable polymer template agent PENOH was not added, other operations were the same as in Example 8. XRD determination showed that the obtained product was amorphous silica. The detailed XRD determination results for the product of Comparative Example 2 are shown in FIG. 5.

### Comparative Example 3

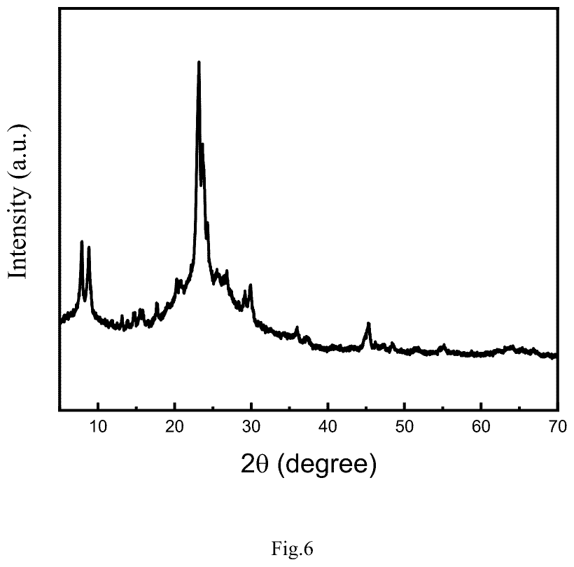

The recyclable polymer template agent PENOH was not added, other operations were the same as in Example 9. XRD determination showed that the obtained product was a mixture of ZSM-5 zeolite and amorphous silica. The detailed XRD determination results for the product of Comparative Example 3 are shown in FIG. 6.

From the comparison of the above Examples 5-9 and Comparative Examples 1-3, it can be seen that the hierarchical pore Beta zeolite synthesized by the method of the present invention contains both micropores and mesopores in its structure, forming a hierarchical pore structure, effectively solving the mass transfer problem existing in traditional Beta zeolite. The phases of the zeolite synthesized by the methods of Comparative Examples 1-3 do not belong to the Beta zeolite, therefore, there is no basis for further discussing whether microporous-mesoporous hierarchical pores are formed inside these zeolites. That is, Comparative Examples 1-3, which do not use the recyclable polymer template agent provided by the present invention, cannot solve the technical problem addressed by the present invention.

Furthermore, from the mesopore size distribution of the hierarchical pore Beta zeolite obtained in Examples 5-9, it can be seen that as the amount of the recyclable polymer template agent increases within an appropriate range, the pore size also increases.

At the same time, the recyclable polymer template agent used in the method of the present invention can be removed solely by centrifugation, can be repeatedly recycled, reduces costs, and improves atom utilization. Moreover, the hierarchical pore Beta zeolite synthesized therefrom does not require high-temperature calcination, avoiding severe dealumination of the zeolite framework, partial framework collapse, and decreased crystallinity, and possesses the advantages of high efficiency, greenness, and environmental friendliness.

In addition, compared with conventional zeolite, the hierarchical pore Beta zeolite synthesized by the method of the present invention has a higher specific surface area of 500-600 m²/g and a pore volume of 0.36-0.72 cm³/g, giving the Beta zeolite better application performance and expanding its application range.

It should be noted that although the various embodiments have been described herein, this does not thereby limit the patent protection scope of the present invention. Therefore, based on the innovative concept of the present invention, changes and modifications to the embodiments described herein, or equivalent structures or equivalent process transformations made using the contents of the description and drawings of the present invention, directly or indirectly applying the above technical solutions in other related technical fields, are all included within the patent protection scope of the present invention.

What is claimed is:

1. A recyclable polymer template agent, characterized in that it has a number average molecular weight of 28,000 to 35,000 g/mol and has the following chemical structural formula:
wherein n is an integer greater than 1.

2. A method for preparing the recyclable polymer template agent according to claim 1, comprising the following steps:
adding isopropylacrylamide and azobisisobutyronitrile to a polymerization tube containing anhydrous tetrahydrofuran, performing an oil bath reaction under a nitrogen protection environment, cooling, evaporating the solvent, dissolving in acetone, then dropwise adding into n-hexane, performing suction filtration, and vacuum drying to obtain poly(N-isopropylacrylamide);
dissolving said poly(N-isopropylacrylamide) in diethyl ether, adding bromoethane, and reacting to obtain a polyquaternary ammonium hydrohalide salt;
treating said polyquaternary ammonium hydrohalide salt with a strongly basic anion exchange resin, and filtering to obtain a polyquaternary ammonium hydroxide solution;
water-bath cooling the polyquaternary ammonium hydroxide solution, adding an acid for neutralization, performing reduced-pressure distillation, cooling again, performing extraction, separating layers, and vacuum removing volatile components to obtain said recyclable polymer template agent.

3. The preparation method according to claim 2, the molar usage ratio of said isopropylacrylamide, azobisisobutyronitrile, and anhydrous tetrahydrofuran is: (8-12):(0.03-0.09):(90-210).

4. The preparation method according to claim 2, the temperature of said oil bath reaction is 55-65° C., the oil bath reaction time is 18-36 h, the temperature of said vacuum drying is 25-30° C., and the vacuum drying time is 40-48 h.

5. The preparation method according to claim 2, the amount of said bromoethane used is 180-420 mmol, the reaction temperature is 40-45° C., and the reaction time is 20-30 h.

6. A method for preparing a hierarchical pore Beta zeolite, comprising the following steps:
mixing water, an aluminum source, an alkali source, and the recyclable polymer template agent according to claim 1 uniformly, and adding a silicon source in batches to obtain a gel, wherein, based on molar parts, said gel comprises 1,500-6,000 parts H2O, 100-300 parts SiO2, 1 part Al₂O₃, 2.0-2.6 parts Na2O, and 0.012-0.026 parts of said polymer template agent;
aging said gel, then placing it in a reaction kettle for crystallization to obtain a sample A;
centrifuging said sample A to remove said recyclable polymer template agent, and drying to obtain said hierarchical pore Beta zeolite.

7. The preparation method according to claim 6, the aging temperature of said gel is 23-25° C., the aging time is 2-4 h, the crystallization temperature is 140-180° C., and the crystallization time is 24-72 h.

8. The preparation method according to claim 6, said aluminum source comprises sodium aluminate and/or aluminum sulfate, said silicon source comprises one or a combination of two or more selected from silica sol, industrial silica gel, and fumed silica, and said alkali source is sodium hydroxide.

9. The preparation method according to claim 6, the centrifugation speed is 5,000-8,000 rpm, the centrifugation temperature is 20-35° C., and the centrifugation time is 10-30 min.

10. A hierarchical pore Beta zeolite prepared by the preparation method according to claim 6, the mesopore pore size of said hierarchical pore Beta zeolite is concentrated in the range of 5-50 nm, the specific surface area is 500-600 m²/g, and the pore volume is 0.36-0.72 cm³/g.
